(19) United States
(12) Patent Application Publication
(10) Pub. No.: US 2006/0001369 A1
(43) Pub. Date: Jan. 5, 2006

(54) Image display method and image display device

(75) Inventors: Naoto Abe, Tokyo (JP); Hiroshi Saito, Kanagawa-ken (JP); Takeshi Ikeda, Kanagawa-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/169,628

(22) Filed: Jun. 30, 2005

(30) Foreign Application Priority Data
Jun. 30, 2004 (JP) 2004-193444

(51) Int. Cl. H01J 11/00; H04N 5/70

(52) U.S. Cl. 313/567; 348/800

(57) ABSTRACT

Provided is an image display method for an image display device including a plurality of electron emission elements and a fluorescent substance that emits light by electron irradiation from the electron emission elements, the method including: storing a fluorescent substance correction value for correcting variation in the light emitted from the fluorescent substance; continually updating an emission current correction value for correcting variation in an emission current; and driving the image display device based on the fluorescent substance correction value and the updated emission current correction value. According to the method, it is possible to correct both the variation in emission currents and the variation in light emitted from fluorescent substances, and to suppress the unevenness of light emitted in the image display device.

### BACKGROUND OF THE INVENTION

1. Field of the Invention

The present invention relates to an image display device in which a large number of electron emission elements are arranged and electron emission is controlled based on image data and an image display method for the image display device. In particular, the present invention relates to an image display method of adequately correcting both the variation in light emitted from fluorescent substances and the variation in emission currents from the electron emission elements and an image display device operated by the image display method.

2. Related Background Art

The following technique has been disclosed in Japanese Patent Application Laid-Open No. 2001-350442 (hereinafter called document 1). According to the technique, in order to realize display of a field emission display (FED) that eliminates non-uniformity in illumination with respect to both initial characteristics and a change with time, luminance information is captured. A correction memory is updated based on the luminance information to correct the change with time.

The following technique has been disclosed in Japanese Patent Application Laid-Open No. 2001-209352 (hereinafter called document 2). In order to realize the display of the FED without non-uniformity in illumination, a fluorescent current flowing through a fluorescent power source for supplying a voltage to a fluorescent panel is measured to correct an output to a cathode panel driver circuit based on the fluorescent current. In addition, a photo-detector is provided at an edge of the fluorescent panel, so a change in light emission characteristic due to deterioration of a fluorescent substance is corrected in addition to the correction based on the fluorescent current.

According to a display device described in the document 1, it is impossible to correct the variation in light emitted from fluorescent substances. In addition, when a change in luminance with time is measured, it is necessary to prepare a dark room and a CCD camera, so this is not realistic for use in a consumer device.

According to a display device described in the document 2, it is possible to correct the deterioration of light emission characteristic of the fluorescent substance with time, which is caused due to, for example, burning of the fluorescent substance. However, the variation in luminance due to the variation in initial light emitted from the fluorescent substances cannot be corrected.

### SUMMARY OF THE INVENTION

An object of the present invention is to allow correction of both the variation in emission currents and the variation in light emitted from fluorescent substances, thereby suppressing unevenness of initial light emitted from an image display device, and to allow correction of the unevenness of the emitted light with time, which is caused due to a change in emission current by measuring the emission current again.

In order to achieve the above object, according to the present invention, an image display method for an image display device including a plurality of electron emission elements and a fluorescent substance that emits light by electron irradiation from the electron emission elements, includes: storing a fluorescent substance correction value for correcting variation in the light emitted from the fluorescent substance; continually updating an emission current correction value for correcting variation in an emission current; and driving the image display device based on the fluorescent substance correction value and the updated emission current correction value.

According to the present invention, it is possible to adequately correct both the variation in the initial light emission characteristics and the change therein with time. Therefore, an image display device that stably displays a uniform image can be provided.

### BRIEF DESCRIPTION OF THE DRAWINGS

FIG. 1 is an explanatory diagram showing an image display device according to the first embodiment of the present invention;

FIG. 2 is an explanatory diagram showing a rear plate of a matrix panel according to the first embodiment of the present invention;

FIG. 3 is a graph showing a characteristic of an electron emission element according to the first embodiment of the present invention;

FIG. 4 is an explanatory diagram showing a modulation driver according to the first embodiment of the present invention;

FIG. 5 is an explanatory diagram showing a correction circuit according to the first embodiment of the present invention;

FIG. 6 is an explanatory diagram showing a correction circuit according to the first embodiment of the present invention;

FIG. 7 is a graph showing variation in light emitted from fluorescent substances;

FIG. 8 is an explanatory diagram showing an image display device according to the second embodiment of the present invention;

FIG. 9 is an explanatory diagram showing a modulation driver according to the second embodiment of the present invention;

FIG. 10 is an explanatory diagram showing a correction circuit according to the second embodiment of the present invention;

FIG. 11 is an explanatory diagram showing a correction circuit according to the second embodiment of the present invention;

FIG. 12 is an explanatory diagram showing a correction circuit according to the second embodiment of the present invention;

FIG. 13 is a graph showing a variation distribution of light emitted from fluorescent substances;

FIG. 14 is a graph showing a variation distribution of an emission current value;

FIG. 15 is an explanatory diagram showing an image display device according to the third embodiment of the present invention;

FIG. 16 is an explanatory diagram showing a correction circuit according to the third embodiment of the present invention;

FIG. 17 is an explanatory diagram showing a correction circuit according to the fourth embodiment of the present invention;

FIG. 18 is an explanatory diagram showing a correction circuit according to the fourth embodiment of the present invention;

FIG. 19 is a graph showing a saturation characteristic of a fluorescent substance;

FIG. 20 is a graph showing a characteristic of a fluorescent substance saturation correction table;

FIG. 21 is a graph showing an example of a modulation wave in a modulation method using a combination of amplitude modulation and pulse width modulation;

FIG. 22 is a graph showing an example of a modulation wave in a modulation method using the combination of amplitude modulation and pulse width modulation;

FIG. 23 is a graph showing an example of a corrected modulation wave in a modulation method using the combination of amplitude modulation and pulse width modulation;

FIG. 24 is a graph showing an example of a corrected modulation wave in a modulation method using the combination of amplitude modulation and pulse width modulation;

FIG. 25 is a graph showing an example of a modulation wave in amplitude modulation;

FIG. 26 is a graph showing an example of a corrected modulation wave in the amplitude modulation;

FIG. 27 is a graph showing an example of a modulation wave in the amplitude modulation;

FIG. 28 is an explanatory diagram showing an If measurement circuit;

FIG. 29 shows a structure for measuring variation in initial light emitted from fluorescent substances;

FIG. 30 shows a structure for measuring variation in initial light emitted from fluorescent substances using the image display device;

FIG. 31 is a flow chart for calculating a fluorescent substance correction value;

FIG. 32 is a flow chart for calculating a fluorescent substance correction value;

FIG. 33 shows a structure for detecting deterioration of a fluorescent substance;

FIG. 34 is a flow chart explaining a correction method in a case where variation in light emitted from fluorescent substances is deteriorated from an initial state;

FIG. 35 is a schematic graph showing variation in luminances in a case where fluorescent substances are deteriorated;

FIG. 36 is a schematic graph showing variation in luminances for each emitted light color in the case where the fluorescent substances are deteriorated;

FIG. 37 is a schematic graph showing a deterioration characteristic of a fluorescent substance;

FIG. 38 is a flow chart explaining a correction method in a case where variation in light emitted from fluorescent substances is deteriorated from an initial state; and

FIG. 39 is a flow chart explaining a correction method in a case where variation in light emitted from fluorescent substances is deteriorated from an initial state.

### DESCRIPTION OF THE PREFERRED EMBODIMENTS

An image display method of the present invention includes an image display method for a surface-conduction electron-emitter display (SED) using a surface-conduction electron-emitter (SCE) as an electron emission element and an image display method for a field emission display (FED) using an electron emission element such as a Spindt type emitter, a graphite-nano-fiber (GNF) emitter, or a carbon-nano-tube (CNT) emitter. In particular, in the cases of a large area SED and a large area FED, unevenness of light emission due to the variation in emission currents from the electron emission elements and the variation in light emitted from fluorescent substances (particularly, the variation in initial light emission) is more likely to occur. Therefore, the image display method is a preferred mode to which the present invention is applied.

According to the present invention, the variation in the emission currents from the electron emission elements is continuously measured, so emission current correction values can be updated. When the unevenness of light emission is caused by deterioration of the fluorescent substance, it is possible to change fluorescent substance correction values.

Therefore, the present invention is suitable for an apparatus used for a long time in which the unevenness of light emitted from an image display device due to a change with time or deterioration becomes a problem, such as a full color television set using the SED or the FED which displays, for example, a natural image, particularly, a moving image.

### First Embodiment

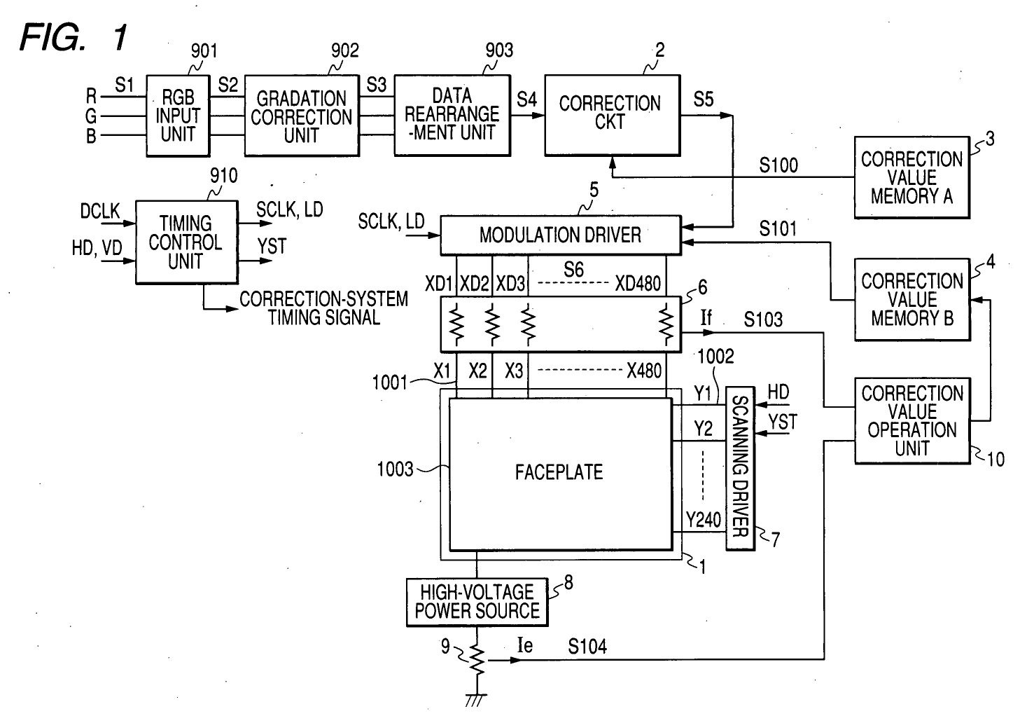

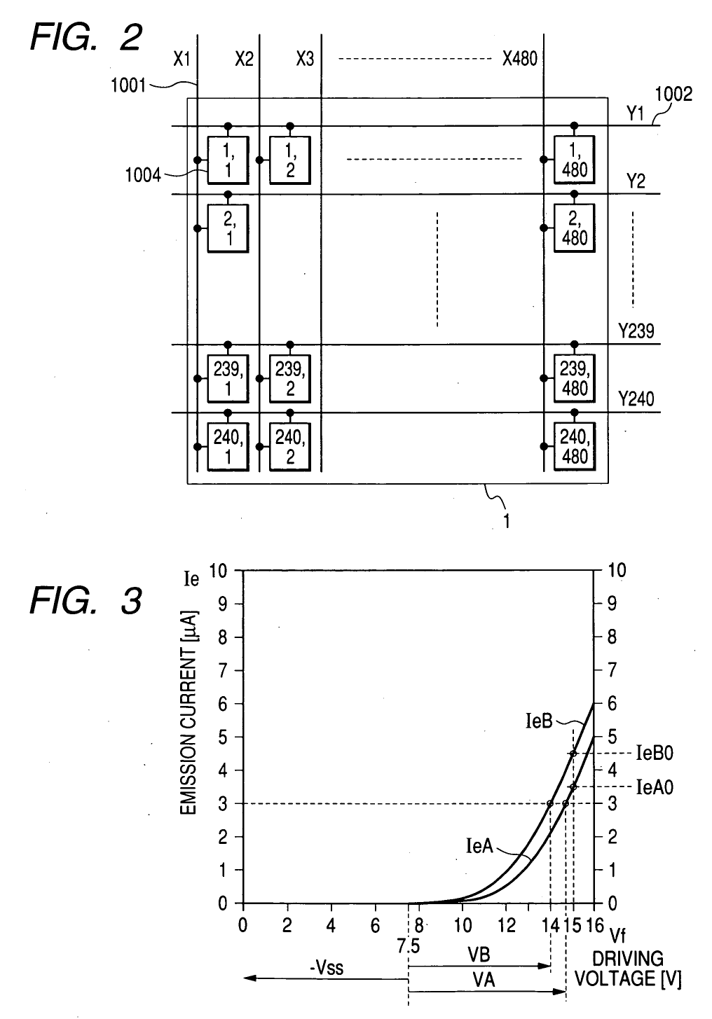

The first embodiment of the present invention will be described with reference to FIGS. 1 and 2.

A matrix panel 1 includes a rear plate having matrix wirings of 240 rows and 480 (160×3 (RGB)) columns and a faceplate 1003 to which a high voltage is applied.

Scanning wirings 1002 are sequentially selected in response to a horizontal synchronization signal of an inputted image signal. A predetermined selection potential is applied from a scanning driver 7 to each of the scanning wirings for a selection period thereof. Modulation signals corresponding to luminance data for the selected scanning wiring 1002 are applied from a modulation driver 5 to modulation wirings 1001 through an If measurement circuit 6 for the selection period. Such operation for the selection period is performed on each of all the rows, so a screen image is formed after one vertical scanning period is completed.

In the present embodiment, the number of scanning wirings is set to 240. When normal TV signals are displayed as in an NTSC system, it is preferable that the number of scanning wirings be 480. When high-definition broadcast signals are displayed, it is preferable that the number of scanning wirings be 720 (720P) or 1080 (1080P). When the number of scanning lines of an input image is different from the number of scanning wirings as described in the present embodiment, it is suitable to make the number of scanning lines of the input image equal to the number of scanning wirings using a scaler etc.

In the first embodiment of the present invention, inputted digital component signals S1 are converted into digital component signals S2 having 240 scanning lines by a scaler of an RGB input unit 901.

When the digital component signals S2 inputted to a gradation correction unit 902 are subjected in advance to gamma correction for canceling a CRT characteristic, the gradation correction unit 902 performs inverse gamma correction in order to cancel a gamma characteristic corrected in advance. It is preferable to realize the gradation correction unit 902 by a table using a memory.

Output signals S3 corresponding to RGB image data from the gradation correction unit 902 are sequentially selected based on the fluorescent substance arrangement of the matrix panel 1 by a data rearrangement unit 903. Each of the sequentially selected output signals is generated as an output signal S4.

A correction value memory A 3 is a memory for storing correction data (fluorescent substance correction values) for correcting the variation in initial light emitted from fluorescent substances opposed to the electron emission elements 1004 of the matrix panel 1. The correction data is stored for each electron emission element (sub pixel). A method of the fluorescent substance correction value will be described later.

When emission currents from the electron emission elements are uniformed, in order to display an image with uniform luminance, a correction circuit 2 corrects the output signal S4 from the data rearrangement unit 903 based on output data S100 from the correction value memory A 3 to generate an output signal S5.

The output signal S5 from the correction circuit 2 is inputted to a modulation driver 5 and subjected to pulse width modulation (PWM) with respect to the modulation wiring 1001 corresponding to a display position of the output signal S5 to generate an output signal S6. A driving current value of the output signal S6 from the modulation driver 5 is measured by an If measurement circuit 6. The driving current measurement will be described later.

The modulation wiring 1001 is driven at a pulse width corresponding to an image by the modulation driver 5 and a selection potential is simultaneously outputted from the scanning driver 7 to the corresponding scanning wiring 1002. The electron emission element 1004 which is connected with the scanning wiring 1002 selected by the selection potential and the modulation wiring 1001 to which a pulse indicating the output signal S6 generated by the pulse width modulation is outputted emits electrons for a time when the pulse is outputted to the modulation wiring 1001.

A high voltage source 8 is connected with the faceplate 1003 of the matrix panel 1 and used to accelerate emission electrons emitted from the electron emission elements 1004. A fluorescent substance corresponding to each of the electron emission elements 1004 emits light in response to the emission electrons with which the fluorescent substance is irradiated. An emission current measuring circuit 9 measures emission currents. The emission current measurement will be described later. An image is displayed on the matrix panel 1.

A correction value memory B 4 stores emission current correction values for uniformly correcting the emission currents, which are calculated by a correction value operation unit 10. The operation of the correction value operation unit 10 will be described later.

An output value S101 from the correction value memory B 4 is outputted to the modulation driver 5 in synchronization with the output signal S5 from the correction circuit 2. That is, a timing control unit 910 generates a timing signal for sequentially outputting the emission current correction values for the electron emission element corresponding to the output signal S5 which is display data.

Next, a method of suitably correcting the variation in light emitted from the fluorescent substances and the variation in emission currents will be described below.

A fundamental idea of correction according to the first embodiment of the present invention is as follows. (1) With respect to the correction of the variation in emission currents, PWM pulse potentials are set to be variable and controlled such that all the emission currents from the electron emission elements become equal to one another. (2) With respect to the correction of the variation in light emitted from the fluorescent substances, the output signal S4 serving as image data which is inputted to the correction circuit 2 is changed into the output signal S5 serving as image data for eliminating the variation in light emission. Therefore, the unevenness of display of the matrix panel is preferably corrected.

<Correction of Emission Current Variation>

First, the correction of variation in emission currents from the electron emission elements will be described.

FIG. 3 is a schematic graph showing a relationship between a driving voltage Vf and an emission current Ie of the electron emission element. Curves IeA and IeB shown in FIG. 3 indicate emission characteristic curves as examples of the variation in emission currents. The abscissa shows −Vss (for example −7.5V), which is the selection potential from the scanning driver 7, and VA and VB, each of which is a pulse potential from the modulation driver 5. A value obtained by adding an absolute value of the selection potential and an absolute value of the pulse potential is applied as the driving voltage Vf to the selected electron emission element.

In the first embodiment of the present invention, the pulse potentials VA and VB are set so as to hold the emission current to a predetermined value regardless of the variation in emission currents IeA and IeB from the electron emission element.

For example, after the measurement of the emission currents, the pulse potentials VA and VB are calculated so as to hold the emission current to the predetermined value by the correction value operation unit 10. The calculated pulse potentials VA and VB are stored as the emission current correction values in the correction value memory B 4 according to image data arrangement. The output value S101 based on the stored emission current correction values is synchronized with a control signal from the timing control unit 910 and inputted to the modulation driver 5 at the same timing as that of the output signal S5 from the correction circuit 2.

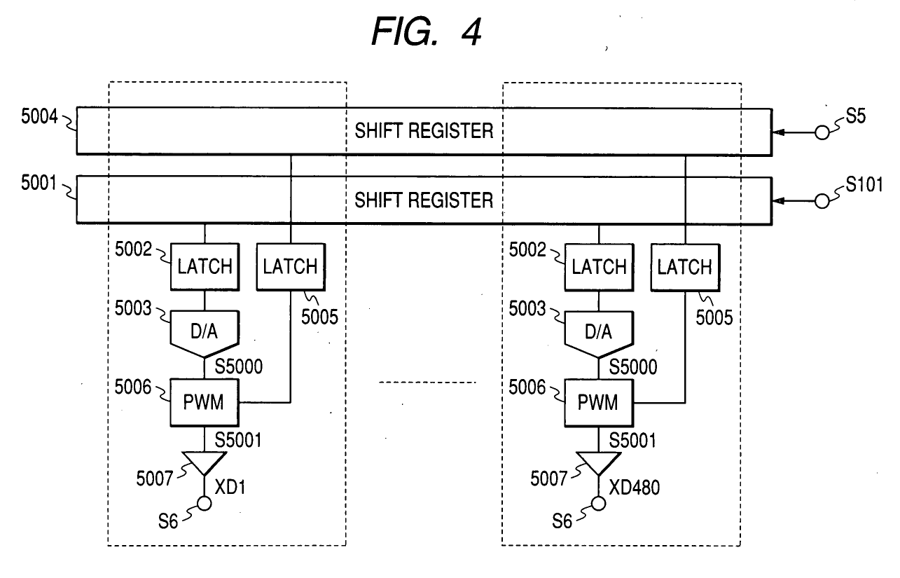

FIG. 4 shows a detailed structure of the modulation driver 5 of the first embodiment.

The output signal S5 sequentially inputted from the correction circuit 2 to the modulation driver 5 is transferred by a shift register 5004 and stored in a latch circuit 5005 connected with the modulation wiring 1001 of a corresponding sub pixel.

The output value (emission current correction value) S101 sequentially inputted from the correction value memory B 4 is transferred by a shift register 5001 and stored in a latch circuit 5002 connected with the modulation wiring 1001 of the corresponding sub pixel.

A D/A converter 5003 outputs a voltage S5000 corresponding to a pulse potential based on the data (emission current correction value) stored in the latch circuit 5002. The voltage S5000 outputted from the D/A converter 5003 is used as the pulse potential. That is, a pulse width modulator 5006 determines a pulse width based on the data stored in the latch circuit 5002.

Then, an output signal S5001 from the pulse width modulator 5006 is outputted as the output signal S6 to the modulation wiring 1001 of the matrix panel 1 through a buffer circuit 5007.

When the pulse potentials VA and VB are stored as the emission current correction values in the correction value memory B 4 so as to hold the emission current to a predetermined value, a pulse potential for holding the emission current to the predetermined value is applied from the modulation driver 5 to the modulation wiring 1001 as described above. Therefore, the variation in emission currents can be corrected.

Emission current values may be stored in the correction value memory B 4 and the emission current correction value which is the output value S101 may be calculated from the emission current values. In such a case, the emission currents are stored as the emission current correction values.

<Calculation of Emission Current Correction Value>

Next, a method of calculating the emission current correction values stored in the correction value memory B 4 will be described.

First, the electron emission elements are separately driven so as to hold the pulse potential on the modulation wiring 1001 to a predetermined value. When the pulse potential is to be held to the predetermined value, the electron emission element may be driven so as to hold the emission current correction value which is the output value S101 to a predetermined value. For example, the value stored in the correction value memory B 4 may be set to a predetermined value. More specifically, the value is set such that the pulse potential becomes 7.5V. When the selection potential is −7.5V, a voltage of 15V is applied to each of the electron emission elements.

The emission current from each of the electron emission elements is measured by the emission current measuring circuit 9. The correction value operation unit calculates a pulse potential when an emission current is held to a predetermined value based on the calculated emission current. For example, in the case of the electron emission element having the characteristic as shown in FIG. 3, it is possible to measure emission currents IeA0 and IeB0 when a driving voltage of the electron emission element having the emission characteristic curves IeA and IeB is 15V. A gradient of the curve indicating the relationship between the driving voltage and the emission current is not almost changed within a variation range regardless of the variation in the electron emission elements. Therefore, the pulse potential (emission current correction value) is calculated from a typical gradient.

When the gradient of the curve indicating the relationship between the driving voltage and the emission current is changed according to the variation in electron emission elements, setting is performed such that the pulse potential becomes 7.5V, and the emission current is measured. Then, setting is performed such that the pulse potential becomes 6.5V and the emission current is measured.

The gradient for each electron emission element can be found from two measurement values based on the graph showing the relationship between driving voltage and emission current in FIG. 3. Therefore, it is possible to calculate the pulse potential (emission current correction value) for holding the emission current to the predetermined value. A data value corresponding to the pulse potential is stored in the correction value memory B 4.

<Correction of Light Emission Variation in Fluorescent Substance>

Next, the fluorescent substance correction values stored in the correction value memory A 3 will be described.

The variation in light emitted from the fluorescent substances as described in the first embodiment of the present invention means the variation in luminance due to the unevenness of the fluorescent substance caused during a process and the unevenness of transmittance of glass even when the emission currents from the electron emission elements do not vary. A correction value for correcting the variation in light emitted from the fluorescent substances is referred to as a fluorescent substance correction value. The fluorescent substance correction value is desirably set for each of the electron emission elements (sub pixels).

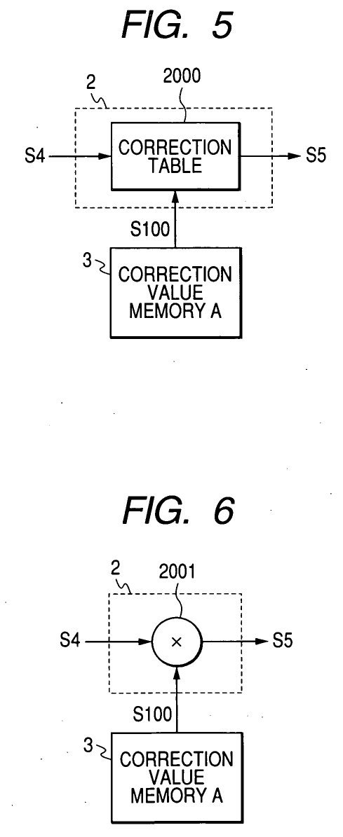

The correction circuit 2 shown in FIG. 1 corrects image data to correct the variation in light emitted from the fluorescent substances. FIG. 5 shows an example of the correction circuit 2. The output signal S4 from the data rearrangement unit 903 and the output data (fluorescent substance correction value) S100 from the correction value memory A 3 are inputted to a correction table 2000. The output signal S5 which is correction data for eliminating the variation in light emitted from the fluorescent substances is outputted from the correction table 2000. In this case, because the correction is performed by the correction table 2000, a variation value of light emitted from the fluorescent substances may be used as the fluorescent substance correction value S100.

In order to correct the variation in light emitted from the fluorescent substances, the electron emission elements are driven in a condition in which the emission currents therefrom are equal to one another. The luminance of each of the fluorescent substances is measured for each of the electron emission elements (sub pixels). A coefficient for holding the luminance to a predetermined value is obtained based on the measured luminance values and image data is multiplied by the coefficient. Therefore, the variation can be corrected.

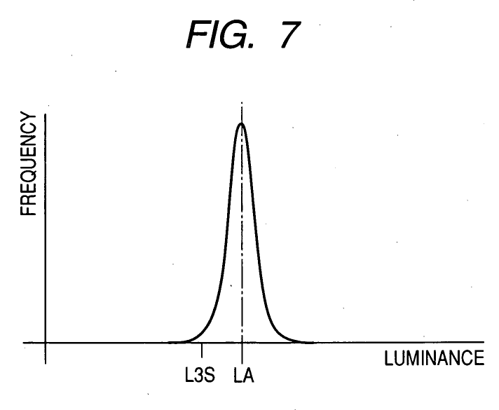

A graph showing a light emission variation distribution (FIG. 7) is obtained. The abscissa indicates a normalized luminance and the ordinate indicates a frequency (the number of sub pixels). Here, assume that a luminance (L3S) reduced from an average LA by, for example, 3σ (σ is a standard deviation) is a luminance target value and a luminance measured in a sub pixel is denoted by Li. Then, a fluorescent substance correction value Hi for the sub pixel is obtained from the following expression (1):
Hi=L3S/Li (1)
The correction data (output signal) S5 is determined by multiplying the image data by the fluorescent substance correction value Hi. In the present embodiment, the luminance reduced by 3σ is set as the luminance target value. A luminance reduced by 2σ may be set.

A value obtained by adding about 10% of a peak-to-peak value in the light emission variation distribution to a minimal value of the luminance may be determined as the luminance target value. In this case, it is an advantage to be able to easily calculate the luminance target value.

FIG. 6 shows another specific example of the correction circuit 2. A multiplier 2001 multiplies the image data S4 by the fluorescent substance correction value S100 which is calculated as described above and stored in the correction value memory A 3. As a result, the corrected image data is outputted as the output signal S5.

Even in an initial state in which the faceplate 1003 is manufactured, there is the variation in light emitted from the fluorescent substances. Therefore, it is necessary that the correction value memory A 3 store fluorescent substance correction values for correcting the variation in (initial) light emitted from the fluorescent substances immediately after manufacturing.

The variation values of light emitted from the fluorescent substances may be stored in the correction value memory A 3 and the fluorescent substance correction value S100 may be calculated based on the variation values. In such a case, the variation values of light emitted from the fluorescent substances are stored as the fluorescent substance correction values. A method of calculating the variation values of initial light emitted from the fluorescent substances will be described later.

As described above, according to the first embodiment of the present invention, even when the variation in emission currents and the variation in light emitted from fluorescent substances occur, the unevenness of light emission can be suitably corrected.

<Sequential Updating of Emission Current Value>

Next, the correction in the case where the emission currents from the electron emission elements such as the SCEs are changed with time or the electron emission elements are deteriorated will be described.

As described above, when the emission currents are measured, a driving voltage applied to each of the electron emission elements is adjusted for the correction. Therefore, when the emission currents are measured as required, the emission current correction values can be calculated, so the unevenness of light emission can be corrected.

In actual, when the emission currents are to be measured, the fluorescent substances emit light based on the emission currents. Therefore, when the emission current measurement is performed while an image is displayed, it is likely to make a user uncomfortable. Thus, for example, the user may provide instructions to start the emission current measurement if necessary. Luminescent spots are displayed on a display screen during the emission current measurement. However, the correction is performed based on the user's intention as in the case where a degauss button of a CRT display is used, so the discomfort is small.

As described in the document 1, the emission currents from all the electron emission elements may be measured during a vertical blanking period. Alternatively, emission currents from a predetermined number of electron emission elements may be sequentially measured during each vertical blanking period. As described in the document 2, an accelerating voltage of the high voltage source may be reduced to measure the emission currents.

As described above, according to the first embodiment of the present invention, the unevenness of light emission can be suitably corrected. Even when the variation in emission current values from the electron emission elements is changed with time or the electron emission elements are deteriorated, the unevenness of light emission can be corrected.

### Second Embodiment

A fundamental idea of correction according to the second embodiment of the present invention is as follows. (1) With respect to the correction of the variation in emission currents, a PWM pulse width is set to be variable (image data is corrected) and controlled such that emission charge amounts from all electron sources become equal to one another. (2) Even with respect to the correction of the variation in light emitted from the fluorescent substances, the output signal S4 serving as image data which is inputted to the correction circuit 2 is changed into the output signal S5 serving as image data for eliminating the variation in light emission (PWM pulse width is changed). Therefore, the unevenness of display of the matrix panel is preferably corrected.

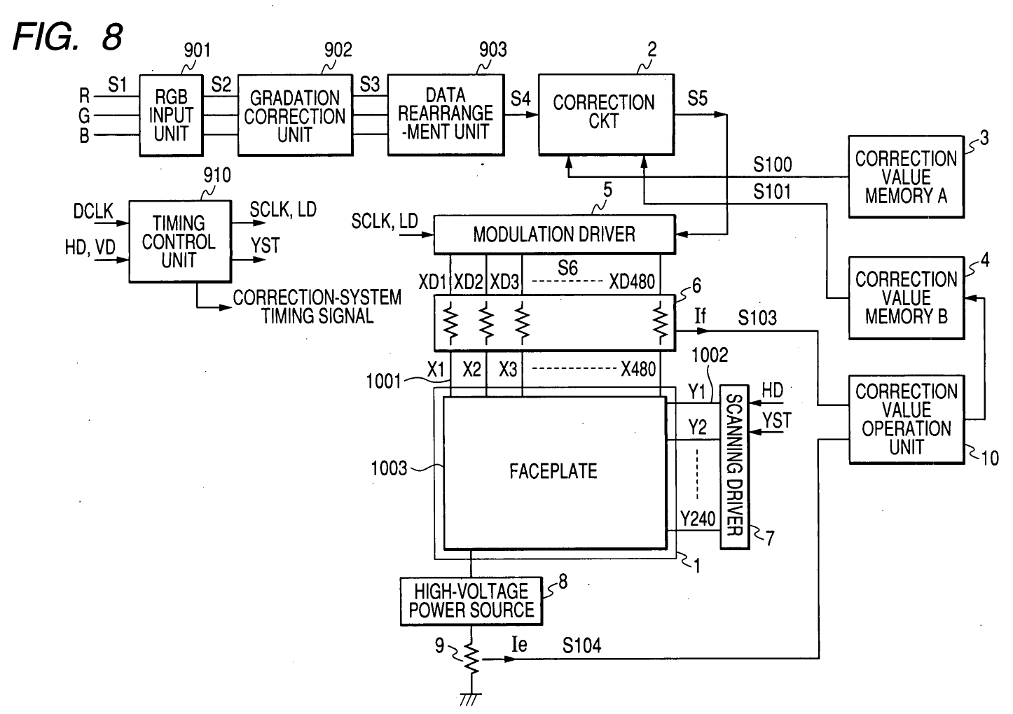

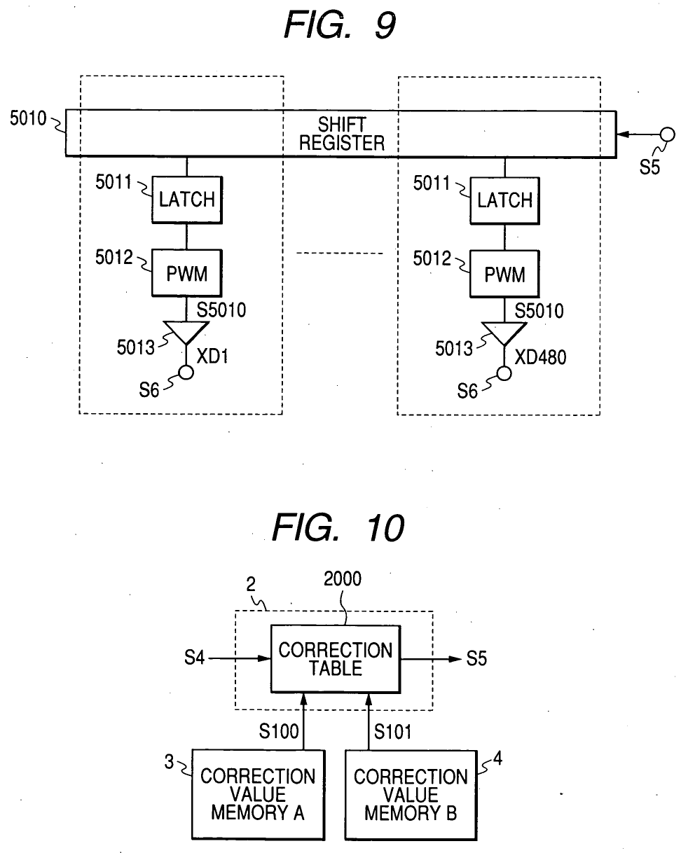

FIGS. 8 and 9 are explanatory diagrams showing the second embodiment of the present invention. FIG. 8 is a functional block diagram identical to that of FIG. 1 and thus the descriptions of the functional blocks and the like are omitted here. In FIG. 8, a large different point is that the output value (emission current correction value) S101 from the correction value memory B 4 is inputted to not the modulation driver 5 but the correction circuit 2. Therefore, the correction circuit 2 and the modulation driver 5 of the second embodiment are different from those of first embodiment.

FIG. 9 shows the modulation driver 5 of the second embodiment.

The output signals S5 sequentially inputted from the correction circuit 2 to the modulation driver 5 are transferred by a shift register 5010 and stored in a latch circuit 5011 connected with the modulation wiring 1001 of a corresponding sub pixel. A pulse width modulator 5012 determines a pulse width of a fixed pulse potential based on the data stored in the latch circuit 5011. Then, an output signal S5010 from the pulse width modulator 5012 is outputted as the output signal S6 to the modulation wiring 1001 of the matrix panel 1 through a buffer circuit 5013.

In the second embodiment, a point different from the first embodiment is that the modulation driver 5 has a function for performing only simple pulse width modulation. As described later, the variation in emission currents is corrected based on the operation of the image data by the correction circuit 2. Therefore, the modulation driver 5 is simplified, so it is possible to reduce particularly a cost of the matrix panel 1 having a larger number of pixels, that is, a large number of modulation wirings.

The correction circuit 2 will be described with reference to FIG. 10. The output signal S4 from the data rearrangement unit 903, the output data (fluorescent substance correction value) S100 from the correction value memory A 3, and the output value (emission current correction value) S101 from the correction value memory B 4 are inputted to the correction table 2000. The output signal S5 which is correction data for eliminating the variation in light emission is outputted from the correction table 2000.

As in the first embodiment, the fluorescent substance correction values stored in the correction value memory A 3 are correction values for correcting the variation in light emitted from the fluorescent substances. The emission current correction values stored in the correction value memory B 4 are correction values for correcting the variation in emission currents using image data (pulse width in the second embodiment).

As shown in FIG. 10, the output signal S4 from the data rearrangement unit 903, the output data S100 from the correction value memory A 3, and the output value S101 from the correction value memory B 4 are inputted to the correction table 2000. The output signal S5 which is corresponding correction data is outputted from the correction table 2000.

Alternatively, the following is preferable. A variation value of light emitted from the fluorescent substances is stored in the correction value memory A 3 and emission current values are stored in the correction value memory B 4. Contents of the correction table 2000 are changed to output the desirable correction data S5. In such a case, the variation values of light emitted from the fluorescent substances and the emission current values are stored as the fluorescent substance correction values and the emission current correction values.

Another example of the correction circuit 2 will be described below. As described above, it is necessary that the output signal S4 from the data rearrangement unit 903, the output data S100 from the correction value memory A 3, and the output value S101 from the correction value memory B 4 be inputted to the correction table 2000. Therefore, there is a disadvantage in that a size of the correction table 2000 becomes larger.

According to the studies made by the inventors of the present invention and the like, the luminance of a fluorescent substance is substantially determined based on a charge amount inputted during one frame display period within a selection time range in multiplexing drive generally performed for an image display device. Although there is a slight difference depending on the type of fluorescent substance, when such a feature is used, the unevenness of light emitted from the image display device can be corrected by simpler hardware in the second embodiment.

That is, a graph showing an emission current value variation distribution (FIG. 14) is obtained. The abscissa indicates an emission current value normalized for each sub pixel and the ordinate indicates a frequency. Here, assume that an emission current value (Ie2S) reduced from an average by, for example, 2σ is an emission current target value and a measured emission current is given by Iei. Then, a fluorescent substance correction value Ji is obtained from the following expression (2):
Ji=Ie2S/Iei (2)
When the image data is multiplied by the obtained fluorescent substance correction value, the charge amount inputted during one frame display period can be held to a predetermined value. Therefore, it has been found that the variation in emission currents can be suitably corrected by a small amount of hardware.
<Correction of Light Emission Variation in Fluorescent Substances and Correction of emission Current variation>

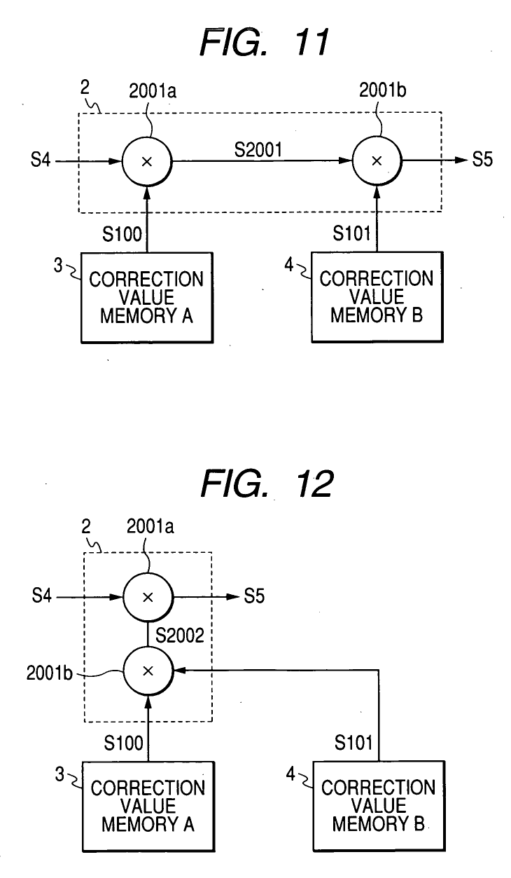

As in the first embodiment shown in FIG. 6, the variation in light emitted from the fluorescent substances is corrected. When the correction circuit 2 has a structure as shown in FIG. 11, the amount of hardware can be reduced, which is preferable. In FIG. 11, the correction circuit 2 includes multipliers 2001a and 2001b. In order to correct the variation in light emitted from the fluorescent substances, the multiplier 2001a multiplies the output signal S4 from the data rearrangement unit 903 and the output data (fluorescent substance correction value) S100 from the correction value memory A 3 together, which are inputted to the multiplier 2001a. Then, the multiplier 2001b multiplies an output from the multiplier 2001a and the output value (emission current correction value) S101 from the correction value memory B 4 together. Note that the output from the multiplier 2001a is obtained by correcting the variation in light emitted from the fluorescent substances. Therefore, the charge amounts inputted during one frame display period are made equal to one another to correct the variation in emission currents.

Next, the fluorescent substance correction values stored in the correction value memory A 3 and the emission current correction values stored in the correction value memory B 4 will be described.

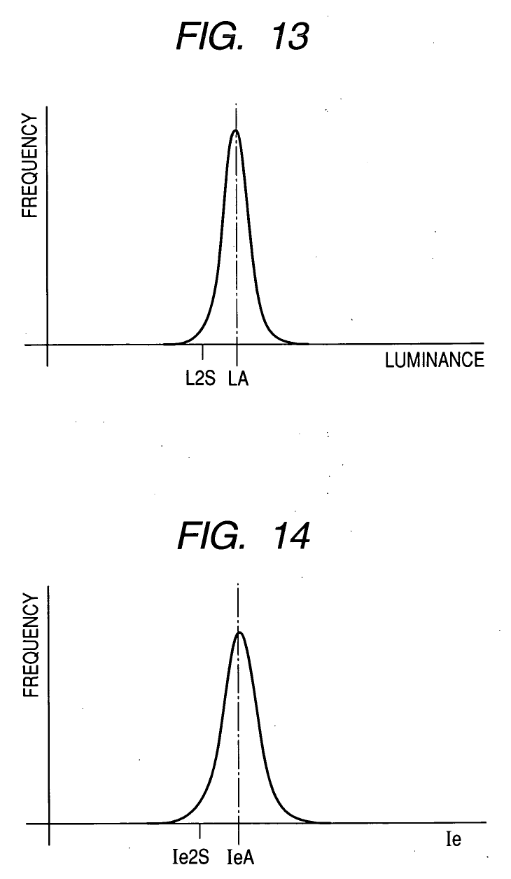

It is suitable to calculate the fluorescent substance correction values stored in the correction value memory A 3 as in the first embodiment. That is, a graph showing a light emission variation distribution (FIG. 13) is obtained. The abscissa indicates a normalized luminance for each sub pixel and the ordinate indicates a frequency. Here, assume that a luminance (L2S) reduced from the average by, for example, 2σ is the luminance target value and the measured luminance is given by Li. Then, a fluorescent substance correction value Hi is obtained from the following expression (3):
Hi=L2S/Li (3)
The image data is multiplied by the obtained fluorescent substance correction value. In the present embodiment, the luminance reduced from the average by 2σ is set as the luminance target value. This is because an electron emission element manufacturing process is different from a fluorescent substance manufacturing process, so the emission current variation distribution and the light emission variation distribution of the fluorescent substances, which are corrected later are stochastically independent of each other. Therefore, it is preferable to set the luminance target value to a large value. It is also preferable to set the luminance target value by the same method as that in the first embodiment. It is more preferable to set the luminance target value to a larger value than that in the first embodiment.

The variation values of light emitted from the fluorescent substances (luminance) may be stored in the correction value memory A 3 and the fluorescent substance correction value S100 may be calculated based on the variation value of light emission (luminance) by the expression (3). Such calculation is sequentially performed. In such a case, the variation values of light emitted from the fluorescent substances are stored as the fluorescent substance correction values.

Next, the emission current correction values stored in the correction value memory B 4 will be described. As described above, the graph showing the emission current value variation distribution (FIG. 14) is obtained. Assume that the emission current value (Ie2S) reduced from the average by, for example, 2σ is the emission current target value. It is suitable to calculate the fluorescent substance correction value Ji by the expression (2).

In the present embodiment, the emission current value (Ie2S) reduced from the average by, for example, 2σ is set as the emission current target value. This is because, as described above, the variation in emission current values and the variation in light emitted from the fluorescent substances are stochastically independent of each other. Therefore, the emission current target value is set to a large value. As in the case of the fluorescent substance correction value calculation, it is also preferable to set the emission current target value by the same method as that in the first embodiment. It is more preferable to set the emission current target value to a larger value than that in the first embodiment.

Image data is multiplied by the fluorescent substance correction value stored in the correction value memory A 3 to correct the variation in light emitted from the fluorescent substances. Then, the image data is multiplied by the emission current correction value for holding a charge amount to a predetermined amount, which is stored in the correction value memory B 4, thereby obtaining the corrected image data. Therefore, the unevenness of light emitted from the image display device can be preferably corrected without changing the pulse potential.

Even in an initial state in which the faceplate 1003 is manufactured, there is the variation in light emitted from the fluorescent substances. Therefore, it is necessary that the correction value memory A 3 store fluorescent substance correction values for correcting the variation in (initial) light emitted from the fluorescent substances immediately after manufacturing. When the emission currents are sequentially measured, the unevenness of light emitted from the image display device can be suitably corrected.

As in the first embodiment, the variation values of light emitted from the fluorescent substances (luminance) may be stored in the correction value memory A 3 and the fluorescent substance correction value S100 may be calculated based on the variation value of light emission (luminance) by the expression (3). Such calculation is sequentially performed. In such a case, the variation values of light emitted from the fluorescent substances are stored as the fluorescent substance correction values.

FIG. 12 shows another example of the correction circuit 2 of the second embodiment. Assume that the output signal S4 which is inputted from the data rearrangement unit 903 to the correction circuit 2 is given by Din and the output signal S5 from the correction circuit 2 is given by Dout. With respect to the multipliers 2001a and 2001b shown in FIG. 11, Dout is expressed by the following expression (4):
Dout=(Din×Ki)×Ji (4)

When the expression (4) is modified, the expression (5):
Dout=Din×(Ki×Ji) (5)
is obtained.

Because the expression (4) is equivalent to the expression (5), the structure shown in FIG. 12 is equivalent to that shown in FIG. 11. Therefore, even when the structure shown in FIG. 12 is used, the unevenness of light emitted from the image display device can be preferably corrected.

### Third Embodiment

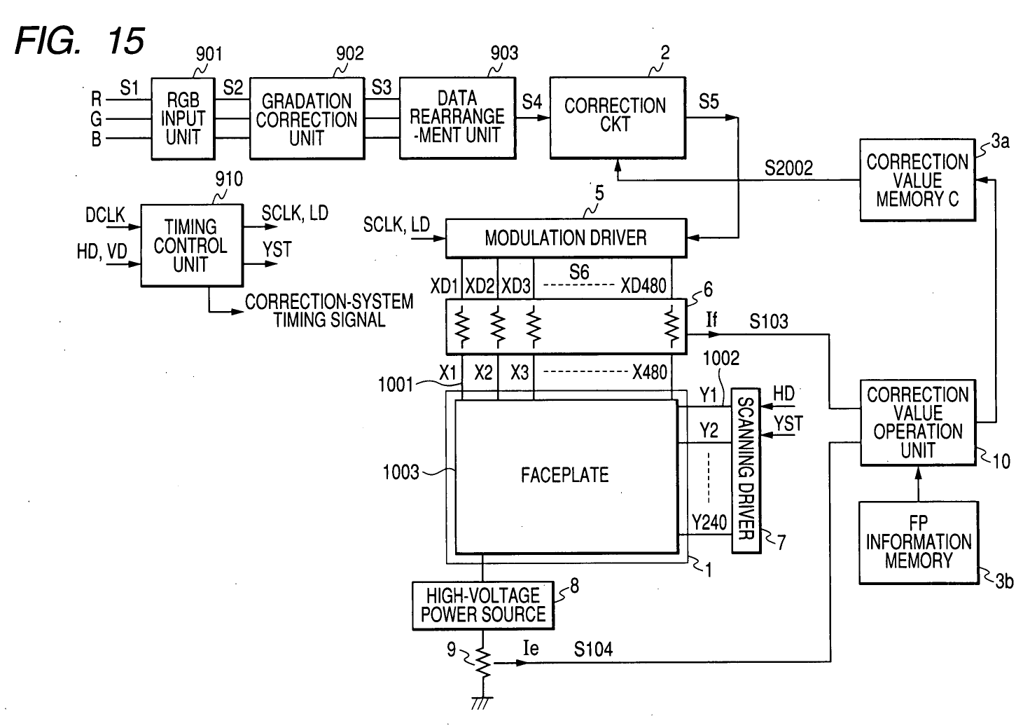

FIG. 15 shows the third embodiment of the present invention.

In FIG. 15, the descriptions of the same functional blocks as those in the second embodiment shown in FIG. 8 and the like are omitted here.

The correction circuit 2 corrects the output signal S4 based on the expression (5) to obtain the output signal S5. Therefore, when a new correction value Mi is expressed by the following expression (6):
Mi=(Ki×Ji) (6)
the following expression (7) can be obtained.
Dout=Din×Mi (7)

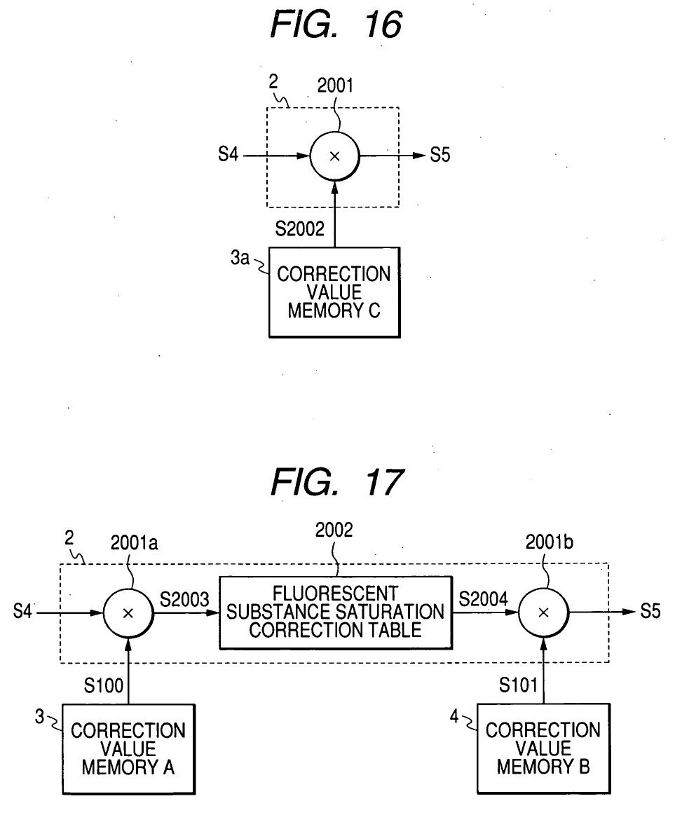

FIG. 16 shows the correction circuit 2 of the third embodiment. The correction value operation unit 10 calculates the new correction value Mi in advance based on contents of an FP information memory 3b and causes a correction value memory C 3a to store the calculated new correction value Mi. Here, when the correction circuit 2 shown in FIG. 16 is used, the unevenness of light emitted from the image display device can be suitably corrected as in the second embodiment. Note that the contents of the FP information memory 3b are suitably the fluorescent substance correction values. The contents of the FP information memory 3b may be the variation values of light emitted from the fluorescent substances.

According to the third Embodiment, the number of multipliers for performing operation at an input timing of image data and the number of readouts of the correction data read at the input timing of image data can be reduced. Therefore, there are advantages in that circuits are simplified and power consumption is reduced.

As in the first and second embodiments, even in the initial state in which the faceplate 1003 is manufactured, there is the variation in light emitted from the fluorescent substances. Therefore, it is necessary that the FP information memory 3b store FP information for correcting the variation in (initial) light emitted from the fluorescent substances immediately after manufacturing (fluorescent substance correction values or the variation values of light emitted from the fluorescent substances).

When the emission currents are sequentially measured, the unevenness of light emitted from the image display device can be suitably corrected.

### Fourth Embodiment

According to the studies made by the inventors of the present invention and the like, the luminance of a fluorescent substance is not linearly changed according to a charge amount for the fluorescent substance and may be saturated.

That is, as shown in FIG. 19, when a normalized charge amount for the fluorescent substance is taken on the abscissa and a normalized luminance is taken on the ordinate, a relationship therebetween is changed according to the type of fluorescent substance (for example, emitted light color).

In FIG. 19, a curve CB indicates an example of a saturation characteristic of blue light, a curve CG indicates an example of a saturation characteristic of green light, and a curve CR indicates an example of a saturation characteristic of red light.

The output signal S4 from the data rearrangement unit 903 is obtained by rearranging the output signals S3 from the gradation correction unit 902. Therefore, the output signal S4 from the data rearrangement unit 903 is data proportional to the luminance.

In the fourth embodiment, the correction circuit 2 having a table for correcting the saturation of the fluorescent substance is provided in order to eliminate the saturation of the fluorescent substance.

The fourth embodiment of the present invention will be described. The fourth embodiment is identical to the second embodiment except that the correction circuit 2 of the fourth embodiment is different from that in the second embodiment.

FIG. 17 shows the correction circuit 2 of the fourth embodiment. Contents of a fluorescent substance saturation correction table 2002 are selected as appropriate according to a color indicated by input data and fluorescent substance saturation correction is performed based on the color indicated by the input data.

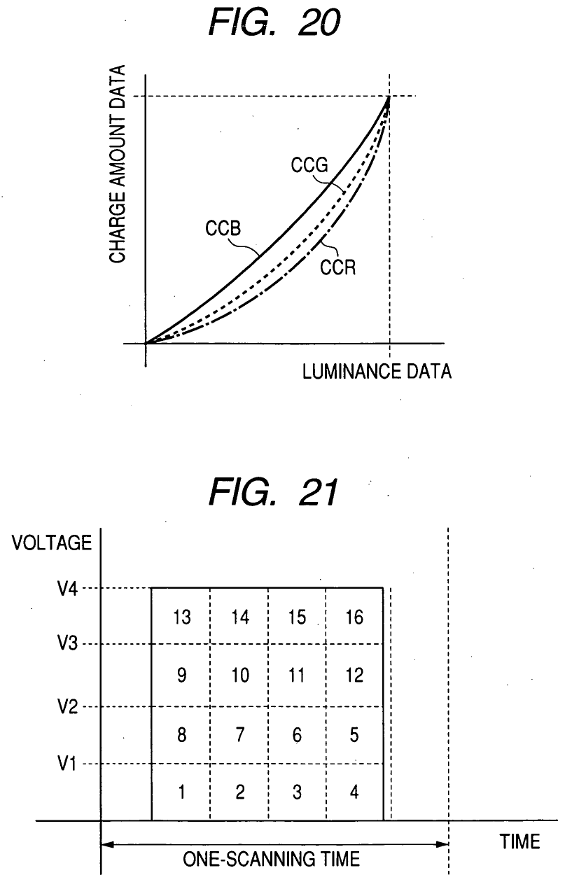

FIG. 20 shows characteristics of the fluorescent substance saturation correction table 2002. In a graph of FIG. 20, the abscissa indicates luminance data inputted to the fluorescent substance saturation correction table 2002 and the abscissa indicates charge amount data which is an output from the fluorescent substance saturation correction table 2002. The luminance data (numeral) and the charge amount data (numeral) are proportional to the luminance and the charge amount, respectively. In order to eliminate the characteristics shown in FIG. 19, the characteristics of the fluorescent substance saturation correction table 2002 are inverse functions of the characteristics shown in FIG. 19. In the graph of FIG. 20, a curve CCB indicates an example of a saturation correction characteristic of blue light, a curve CCG indicates an example of a saturation correction characteristic of green light, and a curve CCR indicates an example of a saturation correction characteristic of red light.

The luminance data is data for specifying the luminance (is equivalent to image data subjected to inverse gamma conversion). When the variation in light emitted from the fluorescent substances is to be corrected, it is suitable to multiply the luminance data by the fluorescent substance correction value from the correction value memory A 3. It is necessary to correct the variation in emission currents so as to hold the charge amount to a predetermined amount. Therefore, when the unevenness of light emitted from the image display device is to be corrected, it is suitable that the luminance data (S4) be multiplied by the fluorescent substance correction value from the correction value memory A 3 by the multiplier 2001a and charge amount data (S2004) be multiplied by the emission current correction value from the correction value memory B 4 by the multiplier 2001b.

According to the fourth embodiment, even when the luminance of the fluorescent substance is saturated, it is possible to suitably correct the unevenness of light emission.

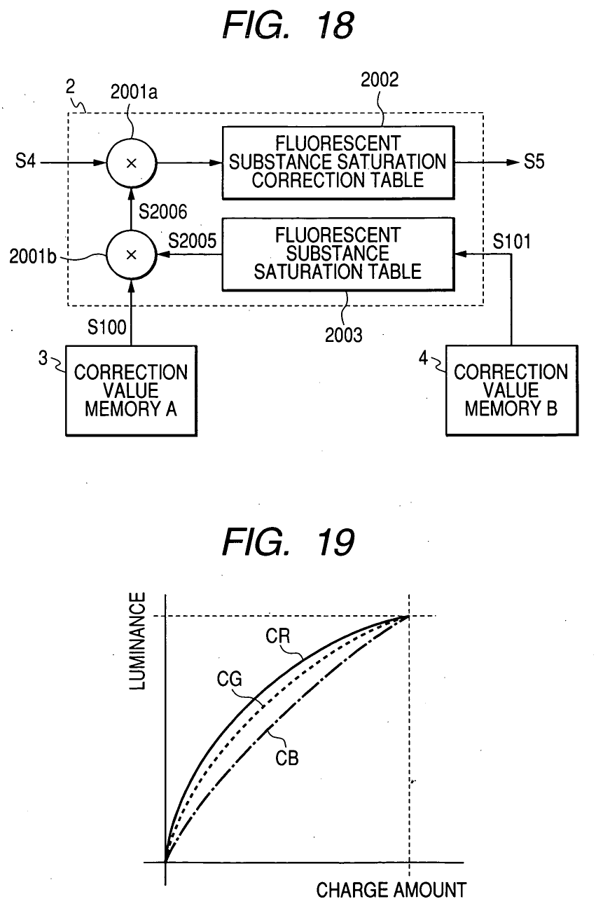

It is also suitable to use the correction circuit 2 having a structure shown in FIG. 18.

Assume that a function of the fluorescent substance saturation correction table 2002 is given by F⁻¹( ), a function of a fluorescent substance saturation table 2003 is given by F( ), the image data (S4) inputted to the correction circuit 2 is given by Din, the output data (S5) from the correction circuit 2 is given by Dout, the fluorescent substance correction value is given by Ki, and the emission current correction value is given by Ji. Then, the structure shown in FIG. 17 is expressed by the following expression (8):
Dout=F⁻¹(Din×Ki)×Ji (8)

The structure shown in FIG. 18 is expressed by the following expression (9):
Dout=F⁻¹(Din×Ki×F(Ji)) (9)

With respect to the function F( ), when the relation of (F⁻¹(α×β)=F⁻¹(α)×F⁻¹(β) (the expression 10)) is established, the expression (8) is identical to the expression (9). Therefore, the structure shown in FIG. 17 is equivalent to that shown in FIG. 18. That is, even when the structure shown in FIG. 18 is used, the unevenness of light emitted from the image display device can be preferably corrected.

The inventors of the present invention have made studies on the fluorescent saturation characteristic, with the result that the inventors have found a luminance L to a charge amount q has a substantial Y-th power characteristic. Therefore,
F(q)=q^{Y} (11)
and an inverse function thereof is
F⁻¹(L)=L^{-Y} (12)

Thus, the relation of the expression (10) is established, so the structure shown in FIG. 17 is equivalent to that shown in FIG. 18. That is, even when the structure shown in FIG. 18 is used, the unevenness of light emitted from the image display device can be preferably corrected.

The third embodiment describes that the single correction value memory is used instead of the two correction value memories. Even in the fourth embodiment, when the output from the multiplier 2001b is calculated in advance and stored in the correction value memory C 3a shown in FIG. 16, the unevenness of light emitted from the image display device can be corrected using the same structure as that in the third embodiment.

As in the third embodiment, it is suitable that the contents of the FP information memory 3b be the fluorescent substance correction values. The contents of the FP information memory 3b may be the variation values of light emitted from the fluorescent substances.

As in the third Embodiment, the number of multipliers for performing operation at an input timing of image data and the number of readouts of the correction data read at the input timing of image data can be reduced. Therefore, there are advantages in that circuits are simplified and power consumption is reduced.

As in the first, second, and third embodiments, even in the initial state in which the faceplate 1003 is manufactured, there is the variation in light emitted from the fluorescent substances. Therefore, when the correction value memory or the FP information memory stores the variation values of (initial) light emitted from the fluorescent substances immediately after manufacturing, the unevenness of luminance of the image display device can be preferably corrected.

When the emission currents are sequentially measured, the unevenness of light emitted from the image display device can be suitably corrected.

### Fifth Embodiment

The fifth embodiment of the present invention will describe that the emission current correction in the first and second embodiments can be performed even in the case where another modulation method is used.

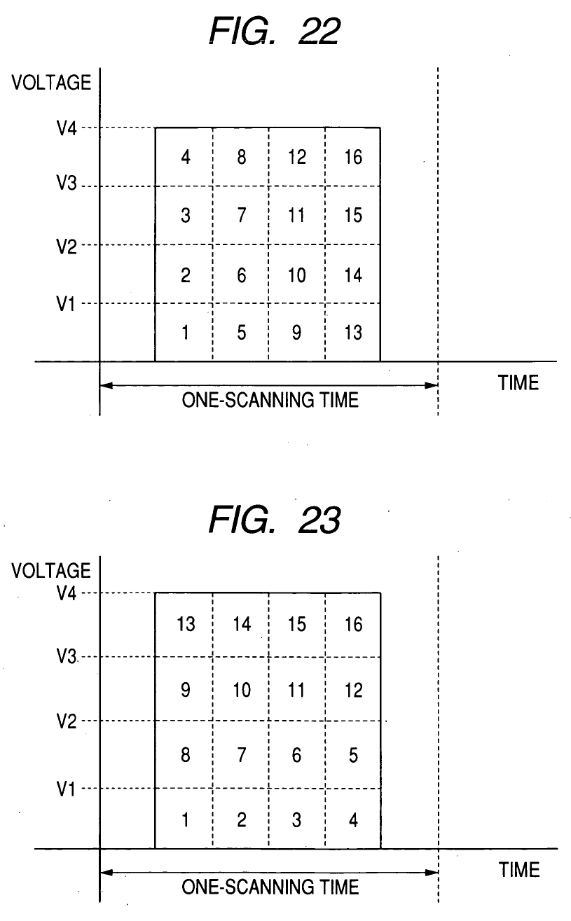

First, the correction of the emission currents using the image data as described in the first embodiment will be described. FIGS. 21 and 22 show examples of modulation waveforms in a modulation method using a combination of amplitude modulation and pulse width modulation. FIGS. 21 and 22 schematically show the modulation waveforms. Respective numerals in the waveforms show that portions indicated by numerals equal to or smaller than a value are outputted when modulation data corresponding to the value is inputted. The modulation method shown in FIG. 21 is a modulation method in which pulse width modulation is firstly performed and a pulse amplitude increases when a pulse width reaches a maximum value. The modulation method shown in FIG. 22 is a modulation method in which amplitude modulation is firstly performed and a pulse width lengthens when a pulse amplitude reaches a maximum value.

In the example of the modulation method shown in FIG. 21, a voltage for eliminating the variation in emission currents is outputted from the correction value memory A 3 to each modulator circuit. For example, a driving voltage applied to an electron emission element having a small emission current value is increased as shown in FIG. 23. A driving voltage applied to an electron emission element having a large emission current value is reduced as shown in FIG. 24. Therefore, the unevenness of light emitted from the image display device can be suitably corrected.

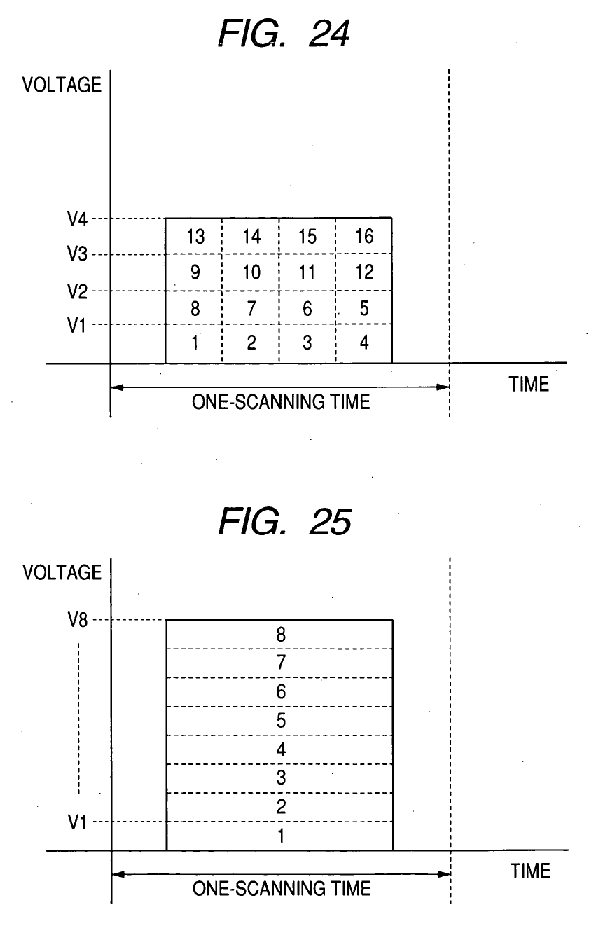

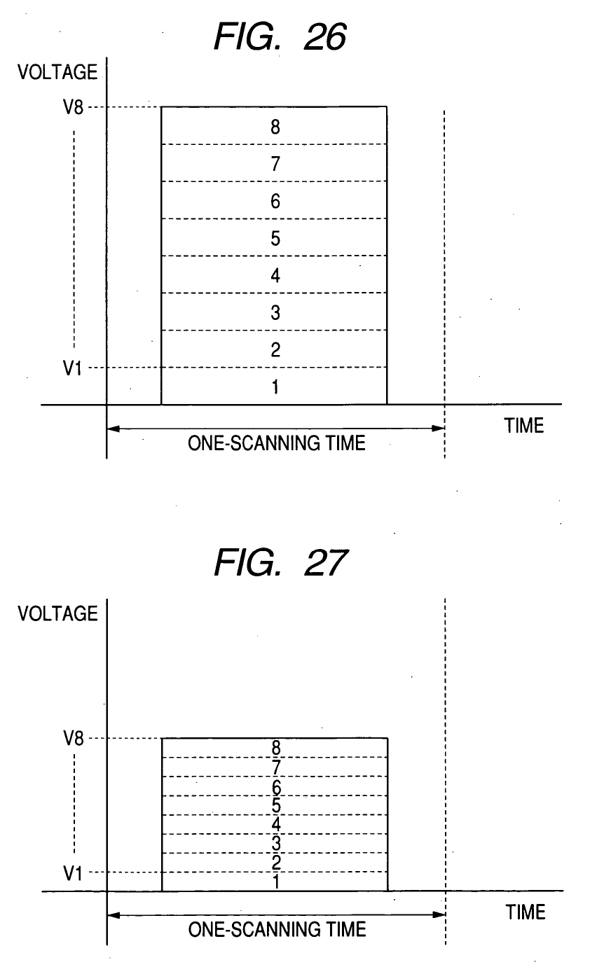

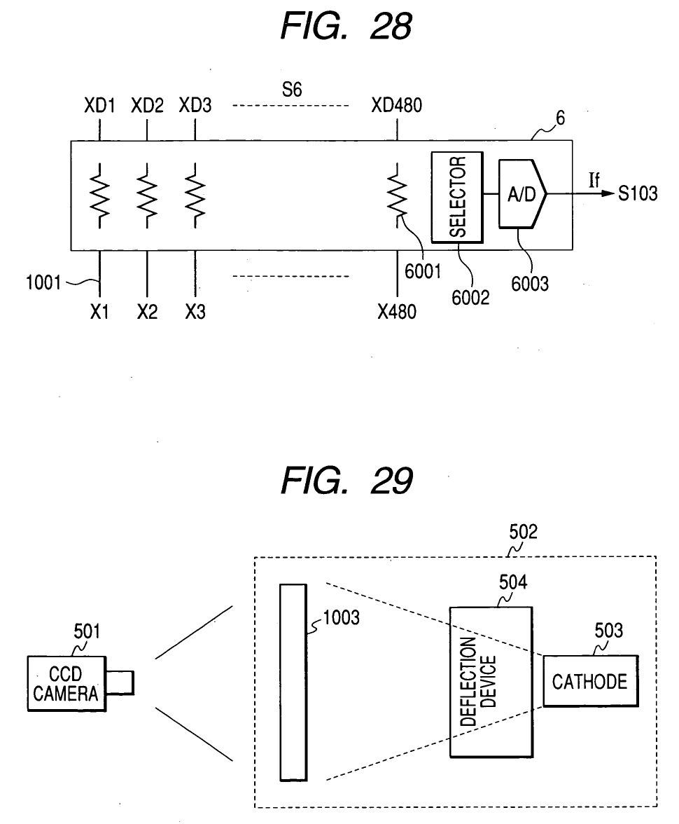

Even in the case of amplitude modulation as shown in FIG. 25, as shown in FIGS. 26 and 27, the driving voltage can be changed to correct the variation in emission currents.

When the emission currents are to be corrected using the image data as described in the second embodiment, for example, the gradation steps in the above-mentioned modulation method may be determined such that charge amounts are equal to one another. The correction can be performed as in the case of pulse width modulation because setting is made such that the light emission luminance of a fluorescent substance is proportional to an applied charge amount. Therefore, the structure according to the present invention can be applied to the other modulation methods.

Hereinafter, a method of obtaining the emission current and the variation in initial light emitted from the fluorescent substances, which is applied to all the embodiments will be described.

(Measurement of Emission Current)

The measurement of the emission current in another embodiment will be described. With respect to the measurement of the emission current, as shown in FIG. 1 and the like, it is suitable to measure a current value of the high voltage source. In this measurement, it is suitable that the driving of electron emission elements other than a target electron emission element be stopped and the current value of the high voltage source become an emission current value of the target electron emission element. When the emission current values of all the electron emission elements are to be measured, the electron emission elements may be lighted one by one to measure the emission current value.

When the SCE is used as the electron emission element, particularly, it is also suitable that a driving current other than an emission current be measured and the measured driving current be converted into the emission current. The efficiency of the SCE is several %, so 90% or more of current thereof is the driving current. In addition, there is a strong correlation between the driving current and the emission current. Therefore, when the driving current is measured and multiplied by the efficiency, the emission current can be calculated.

FIG. 28 shows the If measurement circuit 6. The electron emission element is driven at the same timing as that in the emission current measurement. A terminal voltage of a current detection resistor 6001 of the modulation wiring 1001 connected with the driven electron emission element is selected by a selector 6002. An A/D converter 6003 converts the driving current into digital data. The digital data corresponding to the driving current is multiplied by the efficiency to be converted into the emission current.

In such measurement, the driving current is larger than the emission current. Therefore, there is an advantage in that no high precision is required for a measurement system as compared with the case where the emission current is measured. When the output from the high voltage source 8 is reduced, it is possible to prevent an element (sub pixel) from emitting light during measurement. Therefore, it is preferable for the measurement (calculation) of the emission current.

(Method of Obtaining Variation in Initial Light Emitted from Fluorescent Substances)

An important point of the present invention is to correct the variation in initial light emitted from the fluorescent substances. A method of obtaining the variation in initial light emitted from the fluorescent substances will be described.

<Measurement Method with Electron Beam Irradiation>

FIG. 29 shows the method of obtaining the variation in initial light emitted from the fluorescent substances.

A cathode 503 emits electron beams. A deflection device 504 deflects the electron beams so as to uniformly irradiate the faceplate 1003 with the electron beams. A CCD camera 501 measures light emitted from the faceplate 1003 uniformly irradiated with the electron beams and creates luminance data. As described above, the fluorescent correction values are obtained based on the obtained luminance data. The measurement method using the CCD is described in detail in the document 1, so the description thereof in this specification is omitted here.

<Measurement Method Based on Display of Matrix Panel>

The method of measuring the variation in light emitted from the fluorescent substances irradiated with the electron beams requires a vacuum chamber. Therefore, when a large screen display is used, a size of the image display device increases, so a cost thereof becomes higher.

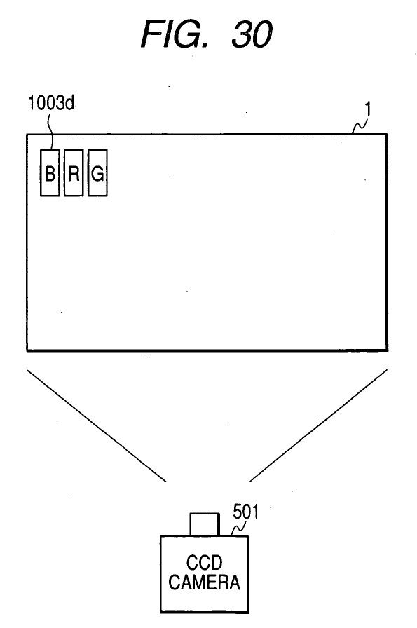

The following method is a method of measuring, as shown in FIG. 30, an image actually displayed on the matrix panel 1 using the CCD camera 501. In this case, the emission currents from the electron emission elements vary, so it is extremely hard to separately measure only the variation in light emitted from the fluorescent substances.

First, a method of performing emission current measurement to correct the emission current (or charge amount) to a predetermined value and then measuring the variation in light emitted from the fluorescent substances will be described.

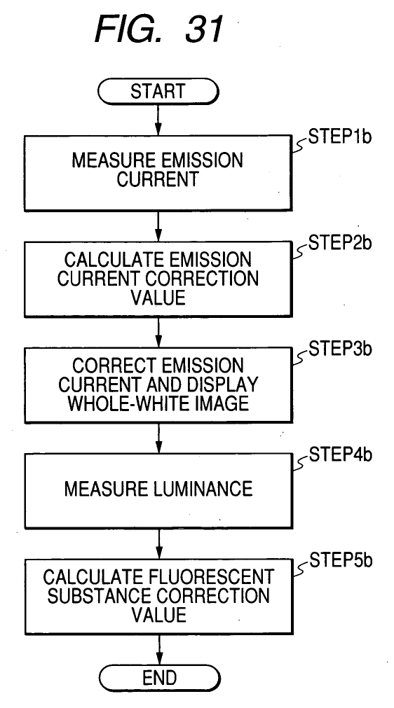

FIG. 31 is a flow chart for calculating a fluorescent substance correction value. In Step STEP1b, an emission current is measured with an initial state of the panel. Next, in Step STEP2b, an emission current correction value is calculated from the measured emission current (variation). In Step STEP3b, the emission current is corrected with a state in which the variation in light emitted from the fluorescent substances is not corrected. Then, a whole-white image is displayed. In Step STEP4b, a luminance is measured. Because the emission current (emission charge amount) is corrected to the predetermined value in Step STEP4b, the variation in luminance measured in Step STEP4b is equal to the variation in light emitted from the fluorescent substances. As described above, in Step STEP5b, a fluorescent substance correction value is calculated. Therefore, it is possible to calculate the fluorescent substance correction value without using the vacuum chamber or the like.

The following method is also suitable. As in the above-mentioned method, the structure shown in FIG. 30 is used. That is, an image actually displayed on the matrix panel 1 is measured using the CCD camera 501. In this case, the emission currents from the electron emission elements vary, so it is extremely hard to separately measure only the variation in light emitted from the fluorescent substances. This method is a method of performing separate operation by calculation to eliminate the variation in emission currents and then calculating a fluorescent substance correction value.

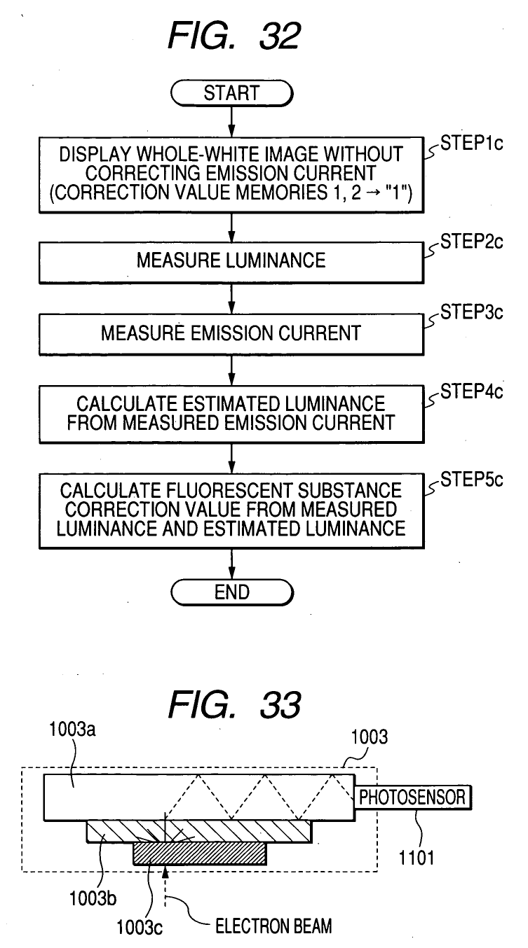

FIG. 32 is a flow chart for calculating the fluorescent substance correction value. In Step STEP1c, a whole-white image is displayed with an initial state of the panel without correcting an emission current. Next, in Step STEP2c, a luminance is measured using the structure shown in FIG. 30. In Step STEP3c, an emission current (variation) is measured. In Step STEP4c, a luminance in the case where there is no variation in luminances of light emitted from the fluorescent substances is estimated based on the emission current measured in Step STEP3c (calculation of estimated luminance). In Step STEP5c, the variation in light emitted from the fluorescent substances is calculated from the luminance measured in Step STEP2c and the luminance estimated in Step STEP4c. Therefore, it is possible to calculate the fluorescent substance correction value without using the vacuum chamber or the like.

(Correction in Case where Variation in Initial Light Emitted from Fluorescent Substance is Deteriorated)

The example in which the variation in initial light emitted from the fluorescent substance is corrected is described in the present invention. A correction method in the case where the variation in light emission is deteriorated from an initial state will be described below.

FIG. 33 shows a structure for detecting the deterioration of a fluorescent substance. A sub pixel in which the deterioration of a fluorescent substance 1003b is to be detected is irradiated with an electron beam from an electron emission element to cause light emission. Light is reflected on a glass plate 1003a and incident on a photosensor 1101. When the variation in initial light emitted from the fluorescent substance is measured, the reflected light is detected by the photosensor 1101. When the deterioration of the florescent substance is to be corrected, the reflected light is measured again. The deterioration of the florescent substance is calculated from a ratio between two luminances to update the variation in light emission.

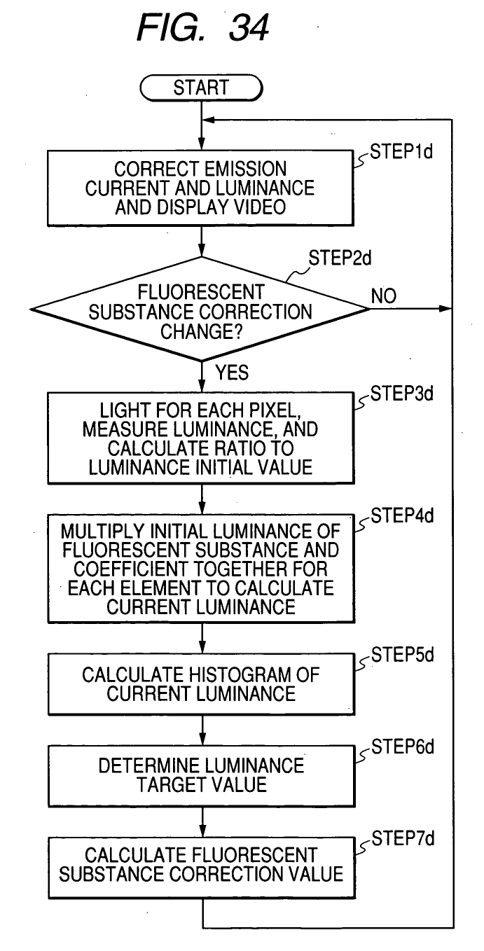

The correction of deterioration of the fluorescent substance will be described with reference to a flow chart shown in FIG. 34. Assume that the variation in initial light emitted from the fluorescent substance (initial luminance) is measured prior to the processing of the flow chart.

In Step STEP1d, normal display is performed by a user. In a product, this indicates that a TV image is actually previewed. For example, when the user determines to change the fluorescent substance value after previewing for a long time (or when an elapsed time exceeds a preset time), in Step STEP2d, the processing advances to subsequent Step STEP3d. In Step STEP3d, as in the emission current measurement, the electron emission elements (sub pixels) are lighted one by one to measure the luminance by the photosensor 1101 and a ratio to an initial value of luminance of a corresponding electron emission element is calculated (calculation of deterioration amount). It is desirable to perform this measurement immediately after the emission current correction value is updated. In Step STEP4d, the variation in initial luminance is multiplied by the deterioration amount for each electron emission element to calculate the variation in current luminance. In Step STEP5d, a histogram of the variation in current luminance is calculated if necessary. In Step STEP6d, a luminance target value is determined as described above. In Step STEP7d, the fluorescent substance correction value is calculated and updated. Then, the processing returns to the normal display (Step STEP1d).

According to the processing flow, the fluorescent substance correction value determined from the variation in initial light emitted from the fluorescent substance can be updated. Even when the fluorescent substance is deteriorated, it is possible to satisfactorily correct the unevenness of light emitted from the image display device. The description using the flow chart has been made by referring to the variation in light emitted from the fluorescent substance as the variation in luminance.

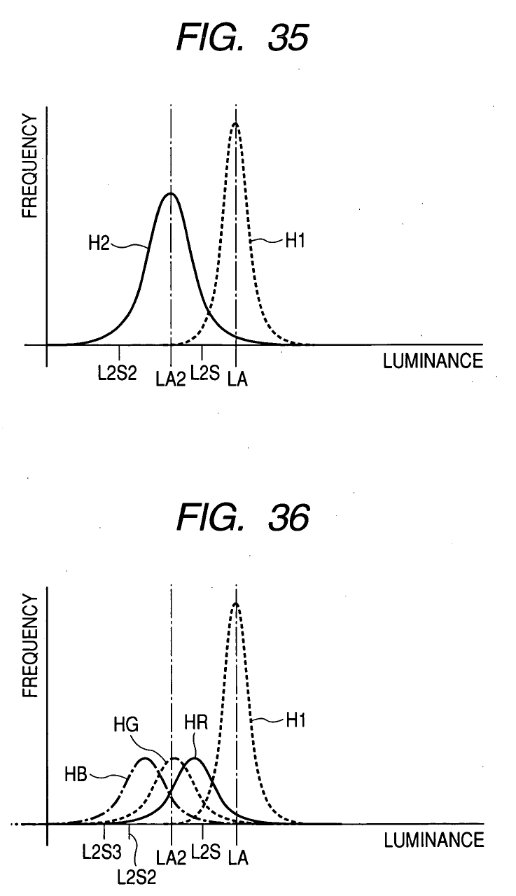

FIG. 35 schematically shows the variation in luminance in the case where the fluorescent is deteriorated. In FIG. 35, the abscissa indicates a normalized luminance and the ordinate indicates a frequency. The calculation of the fluorescent substance correction value as shown in FIG. 34 will be described with reference to FIG. 35. A luminance variation distribution becomes a distribution indicated by Hi in an initial state. On the other hand, according to the calculation in Step STEP5d shown in FIG. 34, the fluorescent substance deteriorates to have a distribution indicated by H2. It is suitable to set a luminance target value to, for example, the luminance L2S reduced from an average by 2σ based on the distribution indicated by H1 in an initial state. In Step STEP6d, the luminance target value is newly set to a luminance L2S2 reduced from an average by 2σ based on the distribution indicated by H2 in which the fluorescent substance is deteriorated. The fluorescent substance correction value is calculated and updated. Therefore, even when the fluorescent substance is deteriorated from an initial state, it is possible to suitably correct the variation in light emitted from the fluorescent substance.

According to the studies made by the inventors of the present invention and the like, a life of the fluorescent substance is changed according to the type thereof, and more specifically, emitted light colors (generally, Red (R), Green (G), and Blue (B)). Therefore, the histogram obtained after the deterioration as shown in FIG. 35 includes distributions having different luminances which are indicated by HR, HG, and HB for respective colors (RGB) as shown in FIG. 36. As described with reference to FIG. 34, with no distinction of the respective colors (RGB), the luminance target value is newly set to the luminance L2S2 reduced from the average by 2σ and the fluorescent substance correction value is calculated and updated. In such a case, for example, a target value of a fluorescent substance (blue (B)) which rapidly deteriorates (which has a low luminance distribution) becomes a high luminance in a luminance distribution of the corresponding color. Therefore, the correction cannot be performed. More specifically, the unevenness of light emitted from the fluorescent substance in the case where simple blue light is emitted becomes larger.

Therefore, in the case of a display using plural types of fluorescent substances, as shown in FIG. 36, it is suitable to determine the luminance target value based on the luminance distribution HB of the fluorescent substance (blue (B)) which rapidly deteriorates (which has a low luminance distribution). That is, a luminance L2S3 reduced from the average of the luminance distribution HB by 2σ may be set. Here, the luminance is normalized for each color such that an average of initial values becomes 1.

Next, the correction in another embodiment in the case where the variation in initial light emitted from the fluorescent substance is deteriorated will be described. According to the above-mentioned method, the deterioration of the fluorescent substance can be measured. However, additional hardware for the photosensor 1101 is required, with the result that an increase in cost and a mechanical limitation are likely to accompany this. Therefore, in the present embodiment, the deterioration of the fluorescent substance is measured in advance by another system to obtain a deterioration characteristic of the fluorescent substance. The deterioration of the fluorescent substance is estimated based on a driving amount (accumulated charge amount) of the fluorescent substance and the deterioration characteristic of the fluorescent substance. Then, the fluorescent substance correction value is calculated and the variation in light emitted from the fluorescent substance is corrected.

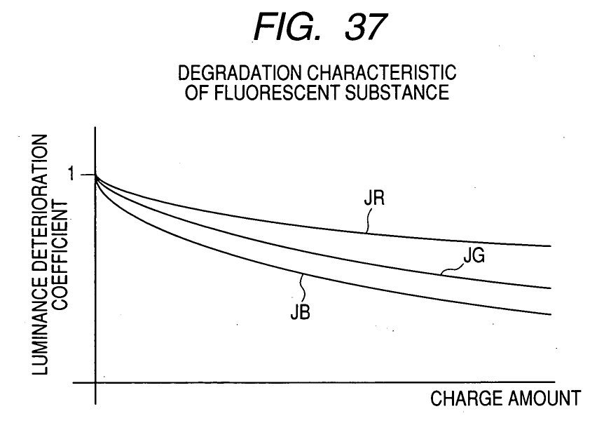

For example, the deterioration characteristics of the fluorescent substances are shown in FIG. 37. In FIG. 37, the abscissa indicates an accumulated charge amount and the ordinate indicates a luminance deterioration coefficient. The respective fluorescent substances having colors (R, G, and B) deteriorate based on curves indicated by JR, JG, and JB.

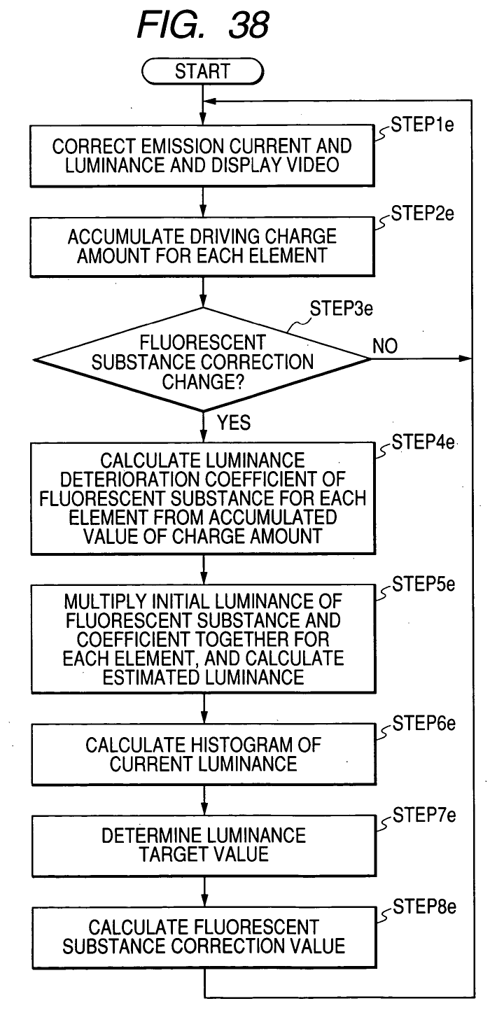

FIG. 38 is a flow chart for updating the fluorescent substance correction value. Assume that the variation in initial light emitted from the fluorescent substance (initial luminance) is measured prior to the processing of the flow chart. In Step STEP1e, normal display is performed by a user. In a product, this indicates that a TV image is actually previewed. In Step STEP2e, an amount of charges actually applied to the fluorescent substance is accumulated while the TV image is previewed. As described above, this is a value obtained by accumulating image data in which the variation in emission current is corrected for each electron emission element. For example, when the user determines to change the fluorescent substance value after previewing for a long time (or when an elapsed time exceeds a preset time), in Step STEP3e, the processing advances to subsequent Step STEP4e. In Step STEP4e, a luminance deterioration coefficient is calculated based on the graph (or function) shown in FIG. 37. In Step STEP5e, the variation in initial luminance is multiplied by the luminance deterioration coefficient for each electron emission element to calculate the variation in current luminance. In Step STEP6e, a histogram of the variation in current luminance is calculated if necessary. In Step STEP7e, the luminance target value is determined as described above. In Step STEP8e, the fluorescent substance correction value is calculated and updated. Then, the processing returns to the normal display (Step STEP1e).

According to the processing flows the fluorescent substance correction value determined from the variation in initial light emitted from the fluorescent substance can be updated. Even when the fluorescent substance is deteriorated, it is possible to satisfactorily correct the unevenness of light emitted from the image display device. The description using the flow chart has been made by referring to the variation in light emitted from the fluorescent substance as the variation in luminance. In the case of the above-mentioned method, additional hardware for the photosensor 1101 is not required. Therefore, the deterioration of the fluorescent substance can be more preferably corrected.

### Other Embodiments

However, it is necessary to set the accumulated charge amount to each electron emission element. Therefore, in the case of an image display device including a large number of electron emission elements, a memory capacity becomes very large, with the result that it is likely to increase a cost.

In general, when a TV image and the like are viewed for a long time, a fixed pattern is displayed in few cases. Therefore, part of the electron emission elements are rarely deteriorated. The deterioration states of the fluorescent substances are different from one another for each of colors thereof, so the color balance of the image display device is shifted in some cases.

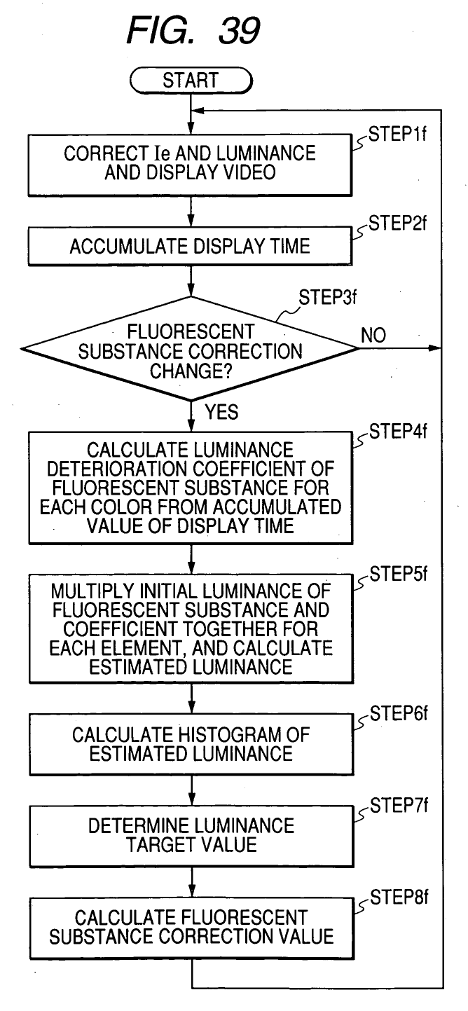

In the following embodiment, a method of correcting the shift of color balance of an image display device for displaying a TV image or the like by using a small amount of hardware will be described with reference to FIG. 39. Assume that the variation in initial light emitted from the fluorescent substance (initial luminance) is measured prior to the processing of the flow chart. As shown in FIG. 39, in Step STEP1f, normal display is performed by a user. In a product, this indicates that a TV image is actually previewed. In Step STEP2f, a TV image display time is accumulated. As described above, this is because the degree of deterioration of each of the fluorescent substances having different colors is estimated. For example, when the user determines that it is necessary to change the fluorescent substance value after previewing for a long time (or when an elapsed time exceeds a preset time), in Step STEP3f, the processing advances to subsequent Step STEP4f. In Step STEP4f, an accumulated charge amount of each of the fluorescent substances having different colors is estimated from an accumulated value of the display time. The luminance deterioration coefficient for each of the colors is calculated based on the graph (or function) shown in FIG. 37. Actually, the accumulated value of the display time may be multiplied by a constant and the luminance target value to estimate the accumulated charge amount and the luminance deterioration coefficient may be calculated based on the relationship shown in FIG. 37. In Step STEP5f, the variation in initial luminance is multiplied by the luminance deterioration coefficient determined for each of the colors of the fluorescent substances for each electron emission element to calculate the variation in current luminance. In Step STEP6f, a histogram of the variation in current luminance is calculated if necessary. In Step STEP7f, the luminance target value is determined as described above. In Step STEP8f, the fluorescent substance correction value is calculated and updated. Then, the processing returns to the normal display (Step STEP1f).

According to the processing flow, the fluorescent substance correction value determined from the variation in initial light emitted from the fluorescent substance can be updated. Even when the fluorescent substance is deteriorated to shift the color balance of the image display device, it is possible to satisfactorily correct the deterioration of the fluorescent substance. In the case of the above-mentioned method, additional hardware for the photosensor 1101 is not required. In addition, it is unnecessary to set a corresponding accumulated value of the charge amount for each electron emission element. That is, the shift of color balance due to the deterioration of the fluorescent substance can be corrected by a small amount of hardware.

The image display device according to the present invention can be applied to an image display system such as a television receiver for receiving a television signal by radio and/or via wire line. More specifically, the present invention can be preferably applied to an image display system including a receiving circuit for receiving a television signal and the image display device that receives a video signal from the receiving circuit and realizes the image display method according to any one of the above-mentioned embodiments.

This application claims priority from Japanese Patent Application No. 2004-193444 filed Jun. 30, 2004, which is hereby incorporated by reference herein.

What is claimed is:

1. An image display method for an image display device including a plurality of electron emission elements and a fluorescent substance that emits light by electron irradiation from the electron emission elements, comprising the steps of:
storing a fluorescent substance correction value for correcting variation in the light emitted from the fluorescent substance;
continually updating an emission current correction value for correcting variation in an emission current; and
driving the image display device based on the fluorescent substance correction value and the updated emission current correction value.

2. An image display method according to claim 1, wherein the step of driving the image display device further comprises the steps of:
correcting image data based on the fluorescent substance correction value and the emission current correction value; and
driving the image display device based on the corrected image data.

3. An image display method according to claim 1, wherein the step of storing the fluorescent substance correction value for correcting the variation in the light emitted from the fluorescent substance further comprises the steps of:
measuring an emission current;
calculating an emission current correction value for correcting variation in the emission current;
driving the image display device based on the emission current correction value;
measuring a luminance of each of the electron emission elements while the image display device is driven; and
calculating the fluorescent substance correction value for correcting the variation in the light emitted from the fluorescent substance based on the luminance.

4. An image display method according to claim 1, wherein the step of storing the fluorescent substance correction value for correcting the variation in the light emitted from the fluorescent substance further comprises the steps of:
driving the image display device based on image data;
measuring a luminance and an emission current of each of the electron emission elements; and
estimating a luminance from the measured emission current and calculating the fluorescent substance correction value for correcting the variation in the light emitted from the fluorescent substance based on the estimated luminance and the measured luminance.

5. An image display method according to claim 1, wherein the fluorescent substance correction value is continually updated.

6. An image display method according to claim 5, wherein the variation in the light emitted from the fluorescent substance is estimated based on an accumulated amount of corrected image data and a deterioration characteristic of the fluorescent substance which is measured in advance, the estimated variation is updated for each of the electron emission elements, and the fluorescent substance correction value is updated based on the updated variation.

7. An image display method according to claim 5, wherein the variation in the light emitted from the fluorescent substance is estimated based on a display time and a deterioration characteristic of the fluorescent substance which is measured in advance, the estimated variation is updated for each type of the fluorescent substance, and the fluorescent substance correction value is updated based on the updated variation.

8. An image display method according to claim 1, wherein:
the step of storing the fluorescent substance correction value for correcting the variation in the light emitted from the fluorescent substance further comprises the step of calculating the fluorescent substance correction value based on a distribution of the variation in the light emitted from the fluorescent substance; and
the step of driving the image display device further comprises the step of calculating the emission current correction value based on a distribution of the emission current.

9. An image display device, comprising:
a plurality of electron emission elements;
a fluorescent substance that emits light by electron irradiation from the electron emission elements;
a first memory adapted to store a fluorescent substance correction value for correcting variation in the light emitted from the fluorescent substance;
a second memory adapted to continually update an emission current correction value for correcting variation in an emission current; and
a driver adapted to drive the image display device based on the fluorescent substance correction value and the updated emission current correction value.

10. An image display device according to claim 9, wherein the driver outputs a modulation signal whose pulse width is modulated based on image data, the pulse width of the modulation signal is corrected based on the fluorescent substance correction value, and a pulse potential of the modulation signal is corrected based on the emission current correction value.

11. A television apparatus, comprising:
an image display device comprising
a plurality of electron emission elements,
a fluorescent substance that emits light by electron irradiation from the electron emission elements,
a first memory adapted to store a fluorescent substance correction value for correcting variation in the light emitted from the fluorescent substance,
a second memory adapted to continually update an emission current correction value for correcting variation in an emission current, and
a driver adapted to drive the image display device based on the fluorescent substance correction value and the updated emission current correction value;
a receiving circuit for receiving a television signal; and
an interface portion for receiving a signal from the receiving circuit and outputting a video signal to the image display device.
